(19) United States
(12) Patent Application Publication
(10) Pub. No.: US 2006/0285518 A1
(43) Pub. Date: Dec. 21, 2006

(54) Method and system of transmitting information from one to many terminals via wireless local area network

(75) Inventors: Yeong-shuenn Lin, Hsinchu (TW); Chan-lung Wu, Hsinchu (TW); Tse-hung Chu, Hsinchu (TW)

Correspondence Address: PAI PATENT & TRADEMARK LAW FIRM, 1001 FOURTH AVENUE, SUITE 3200, SEATTLE, WA, 98154, US

(73) Assignee: NEWSOFT TECHNOLOGY CORPORATION

(21) Appl. No.: 11/453,718

(22) Filed: Jun. 15, 2006

(30) Foreign Application Priority Data
Jun. 15, 2005 (TW) 94119883

(51) Int. Cl. H04Q 7/00

(52) U.S. Cl. 370/329; 370/913

(57) ABSTRACT

A method of transmitting information from one to many terminals via wireless local area network (WLAN) is implemented in a WLAN including a first electronic device, and a plurality of second electronic devices. The method includes steps of: the first electronic device searching for the plurality of second electronic devices; the first electronic device designating one of the plurality of second electronic devices to be a primary receiving end; the first electronic device requesting the rest of the plurality of second electronic devices to change their channels to be the same as the channel of the primary receiving end; and the first electronic device transmitting information to the primary receiving end, and the rest of the second electronic devices intercepting the information and outputting the same. A system of transmitting information from one to many terminals via WLAN is also disclosed.

### BACKGROUND OF THE INVENTION

a) Field of the Invention

The invention relates to a method and a system of transmitting information via wireless local area network and, more particularly, to a method and a system of transmitting information from one to many terminals via wireless local area network.

b) Description of the Related Art

A wireless local area network (WLAN) has high scalability and is easy to administrate, and its wireless access points (APs) can be added easily without spending an excessive amount of money on cable implementations or expansions, such that compatible communication equipments can communicate with one another via the wireless APs. Therefore, the communication cost for WLAN can be lowered substantially, especially in system installation and maintenance. Besides, a WLAN has more advantages over a wired network in both the convenience of network installation and the mobility of its use. The WLAN technology is most suitable for places where it is hard to wire and requires no physical infrastructure of LAN, for instance, a temporary network installation for an exhibition ground, a historical building worth preserving, or for offices or houses trying to avoid damaging its upholstery, etc.

Under the current WLAN technology standard, such as IEEE 802.11, two types of transmission mode are specified: the ad-hoc mode as shown in FIG. 1A and the infrastructure mode as shown in FIG. 1B. Under the ad-hoc mode, each of stations (STA) 101, 102, 103 can communicate with other STAs using wireless network card to form a network. Under the infrastructure mode, each of STAs 101, 102, 103 can communicate with other STAs through an AP 104 to form a network. The AP 104 can also be connected to a wired network 106 such as an Ethernet, and through the gateway 105 of the wired network 106 to the Internet 107.

According to the IEEE 802.11 standard, in order to transmit information from one to many terminals, the only way is to rely on the broadcast packets of the medium access control layer (MAC layer). However, the experimental data shows that the chance of missing broadcast packets is very high and the amount of data transmitted may be reduced by almost 20%. Thus, it is difficult to achieve the object of transmitting from one to many terminals using the method of broadcasting.

In comparison with the wired network, it is easier to suffer external interference when data is transmitted via WLAN. Therefore, it is designed at the bottom layer of a network such that hardware can test and verify the validity of a network packet based on the Cyclic Redundancy Check Code (CRC). If the network packet is valid, the receiving end sends an acknowledgement (ACK) to notify the transmitting end that the network packet has been transmitted completely. If, after a predetermined period, the transmitting end does not receive an ACK from the receiving end, it activates a resend process and retransmits the network packet with no returned ACK. However, when transmitting a broadcasting packet, the receiving end does not send an ACK when it receives the broadcasting packet, and the transmitting end considers the transmission as successful after it broadcasts the packet. Thus, the transmitting end does not know the actual transmission status. This is one of the major causes of missing broadcasting packets or receiving incorrect broadcasting packets.

Referring to FIG. 1A, it depicts a conventional technology that was proposed to achieve transmitting information from one to many terminals. When a transmitting end STA 101 wants to transmit the same information to receiving end STAs 102 and 103, the STA 101 first communicates with one of the receiving end STAs (for example, STA 102) on a one-to-one basis, and then the STA 102 checks if the network packet is lost or incorrect and in return, provides an ACK or requests for the network packet to be resent. Due to the characteristics of WLAN transmission, the remaining receiving end STA 103 can scan all usable WLAN transmission channels to intercept network packets, including setting information of wireless network configuration that is periodically transmitted by STA 101. The STA 103 can change its wireless network configuration according to the setting information to receive subsequent information transmitted by STA 101. If the STAs 101, 102, 103 communicate in infrastructure mode, the transmitting end can request the receiving ends to switch to ad-hoc mode before performing the above-mentioned method to achieve the object of transmitting information from one to many terminals.

Although the above-mentioned conventional technology can achieve the object of transmitting information from one to many terminals, users must perform setting operation for each receiving end. When there is a large number of receiving ends, times of performing setting operation increases accordingly, or when receiving ends lack friendly user interfaces, the difficulty of performing setting operations increases. Therefore, how to simplify the setting operation of wireless network configuration of the receiving ends is a goal to be achieved.

### SUMMARY OF THE INVENTION

In view of the above-mentioned problem, an object of the invention is to provide a method and a system of transmitting information from one to many terminals via wireless local area network (WLAN) where the setting operation of the wireless network configurations of a plurality of receiving ends can be performed at a transmitting end at once, so that the plurality of receiving ends can receive information transmitted by the transmitting end simultaneously.

In order to achieve the above-mentioned object, a method of transmitting information from one to many terminals via WLAN of the invention is implemented in a WLAN including a first electronic device and a plurality of second electronic devices. The method includes the steps of: the first electronic device searching for the plurality of second electronic devices that have set their wireless network configurations; the first electronic device designating one of the plurality of second electronic devices to be a primary receiving end; the first electronic device requesting the rest of the plurality of second electronic devices to change the channel of their wireless network configurations to be the same as that of the primary receiving end; and the first electronic device transmitting information to the primary receiving end and the rest of the plurality of second electronic devices intercepting the information and outputting the same.

A system of transmitting information from one to many terminals via WLAN of the invention includes: a first electronic device for transmitting information; and a plurality of second electronic devices signal-connected to the first electronic device via WLAN for receiving the information and outputting the same. The first electronic device searches for the plurality of second electronic devices that have set their wireless network configurations and designates one of the plurality of second electronic devices to be a primary receiving end. Then, the first electronic device requests the rest of the plurality of second electronic devices to change the channel of their wireless network configurations to be the same as the channel of wireless network configuration of the primary receiving end. Next, the first electronic device transmits information to the primary receiving end and the rest of the plurality of second electronic devices intercept the information.

According to the method and system of transmitting information from one to many terminals via WLAN of the invention, the second electronic device that has been designated as the primary receiving end can check whether a network packet is lost or incorrect, and in return provides an acknowledgement (ACK) or requests for the network packet to be resent, and so the problems that a broadcast packet is lost or incorrect can be avoided. Furthermore, according to the method and system of transmitting information from one to many terminals via WLAN of the invention, a user at the transmitting end can set the wireless network configurations of the plurality of receiving terminals at once.

### BRIEF DESCRIPTION OF THE DRAWINGS

FIG. 1A is a schematic diagram illustrating the architecture of a conventional WLAN in ad-hoc mode.

FIG. 1B is a schematic diagram illustrating the architecture of a conventional WLAN in infrastructure mode.

FIG. 2 is a schematic diagram illustrating the operating process of a method and a system of transmitting information from one to many terminals via WLAN according to one preferred embodiment of the invention.

FIG. 3 is a flow chart illustrating the operating process of a first electronic device of a method and a system of transmitting information from one to many terminals via WLAN according to one preferred embodiment of the invention.

FIG. 4 is a flow chart illustrating the operating process of a second electronic device of a method and a system of transmitting information from one to many terminals via WLAN according to one preferred embodiment of the invention.

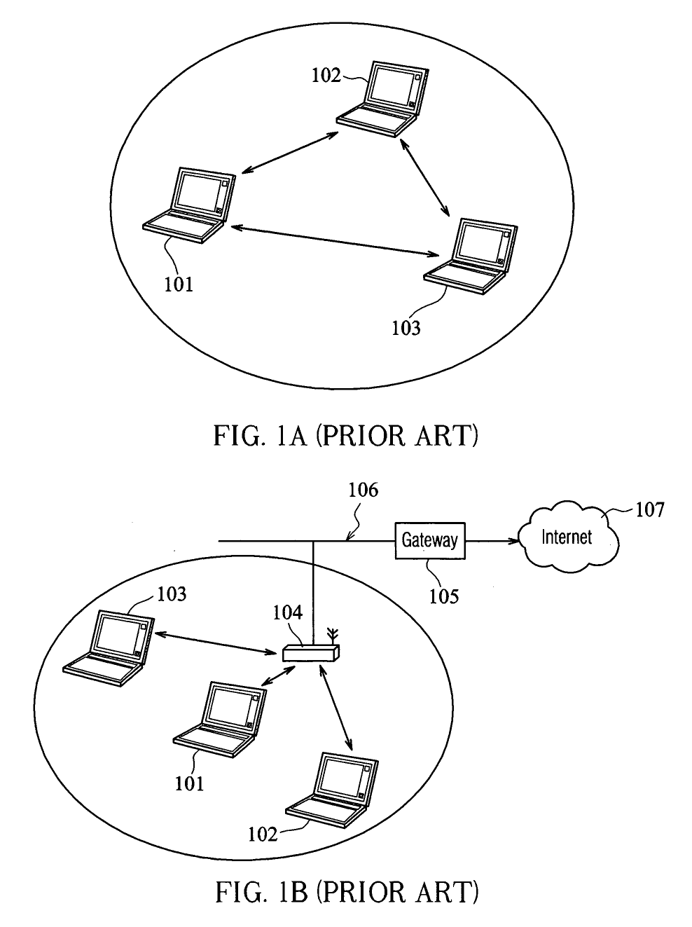

### DETAILED DESCRIPTION OF THE INVENTION

A method and a system of transmitting information from one to many terminals via WLAN according to preferred embodiments of the invention will be described below with reference to the drawings, wherein like reference numerals denote like components.

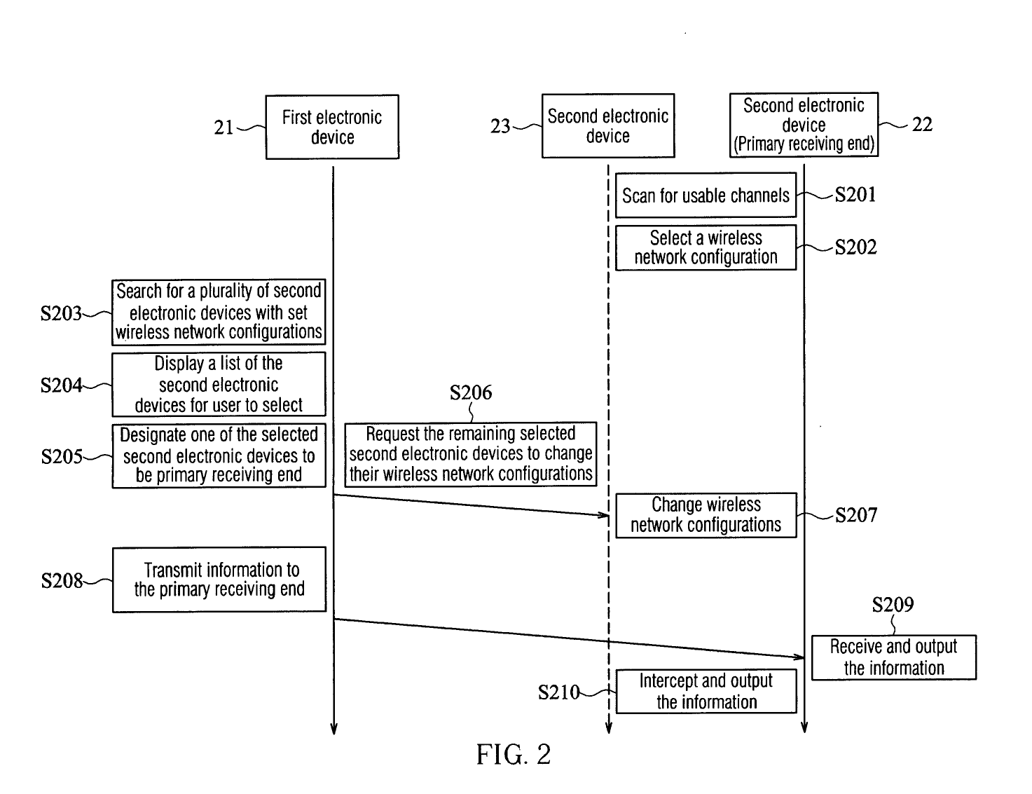

A method of transmitting information from one to many terminals via WLAN according to a preferred embodiment of the invention is implemented in a WLAN including a first electronic device 21 and a plurality of second electronic devices 22, 23. FIG. 2 illustrates the steps in the method of transmitting information from one to many terminals via WLAN according to a preferred embodiment of the invention. First, the second electronic devices 22, 23 scan all usable channels in the WLAN (S201) and each of the second electronic devices 22, 23 selects one of the channels to be its wireless network configuration (S202).

Next, the first electronic device 21 searches for the second electronic devices 22, 23 that have set their wireless network configurations (S203), and displays a list of the second electronic devices 22, 23 for an user to select which of the second electronic devices 22, 23 are to receive information (S204). The first electronic device 21 designates one of the information-receiving second electronic devices 22, 23 to be a primary receiving end (S205), take the illustration shown in FIG. 2 as an example, the first electronic device 21 designates the second electronic device 22 as the primary receiving end.

Since the channel of the wireless network configuration of the second electronic device 23 that is not the primary receiving end may not be the same as the channel of the wireless network configuration of the second electronic device 22 that has been designated as the primary receiving end, the first electronic device 21 requests the second electronic device 23 to change the channel of its wireless network configuration to be the same as the channel of the wireless network configuration of the second electronic device 22 (S206). The second electronic device 23 then change its wireless network configuration (S207) and thus is able to communicate with the first electronic device 21. Last, the first electronic device 21 transmits information to the second electronic device 22 that has been designated as the primary receiving end (S208), and the second electronic device 22 receives the information and output the same (S209). At the same time, the second electronic device 23 can utilize the transmission characteristics of WLAN to intercept and receive the information and output the same (S210).

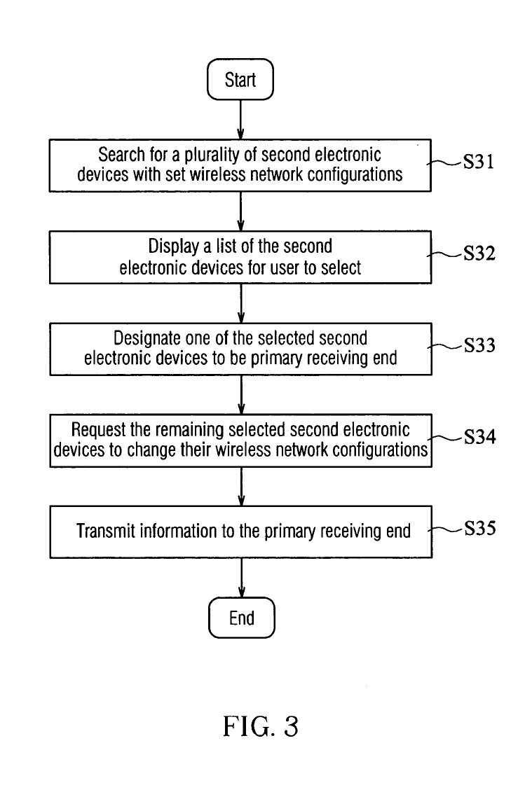

The operating process of the first electronic device 21 is described in FIG. 3. First, the first electronic device 21 searches for the second electronic devices 22, 23 that have set their wireless network configurations (S31). For example, in the Microsoft Windows XP operating system, the IEEE 802.11 WLAN object identifiers (OIDs), for example, OID_{—}802_{—}11_BSSID_LIST_SCAN together with OID_{—}802_{—}11_BSSID_LIST, can be used as commands to request the driver of IEEE 802.11 network card to search for all the second electronic devices 22, 23 that have set their wireless network configurations and gather information such as the service set identifier (SSID) and channel number corresponding thereto.

The first electronic device 21 displays the search result as a list of the second electronic devices 22, 23 for the user to select which of the second electronic devices 22, 23 are to receive information (S32); then the first electronic device 21 designates one of the selected second electronic devices 22, 23 to be the primary receiving end (S33). The first electronic device 21 can designate a second electronic device in the list that is set to a clean channel or a channel with less interference as the primary receiving end, for example, designating the second electronic device 22 to be the primary receiving end. Next, the first electronic device 21 requests the second electronic device 23 that is not the primary receiving end to change the wireless network configuration, so that the channel of the second electronic device 23 is the same as the channel of the second electronic device 22 (S34). For example, the first electronic device 21 can transmit set-packets in the channel of the second electronic device 23, requesting the second electronic device 23 to change its wireless network configuration, and then switch back to the channel of the second electronic device 22. Last, the first electronic device 21 transmits information to the second electronic device 22 that has been designated as the primary receiving end on a one-to-one basis (S35).

The first electronic device 21 can provide several different types of information to be transmitted on WLAN, for example, information in the form of video, audio, image, graphics, text, presentation, and so on. Therefore, the first electronic device 21 can be a computer, a personal digital assistant (PDA), a mobile phone, a wireless projector adapter, a wireless setup box, a wireless digital media adapter (wireless DMA), a wireless optical disc player, a wireless DVD player, a wireless video recorder, a wireless game console, a wireless portable media player, and so on.

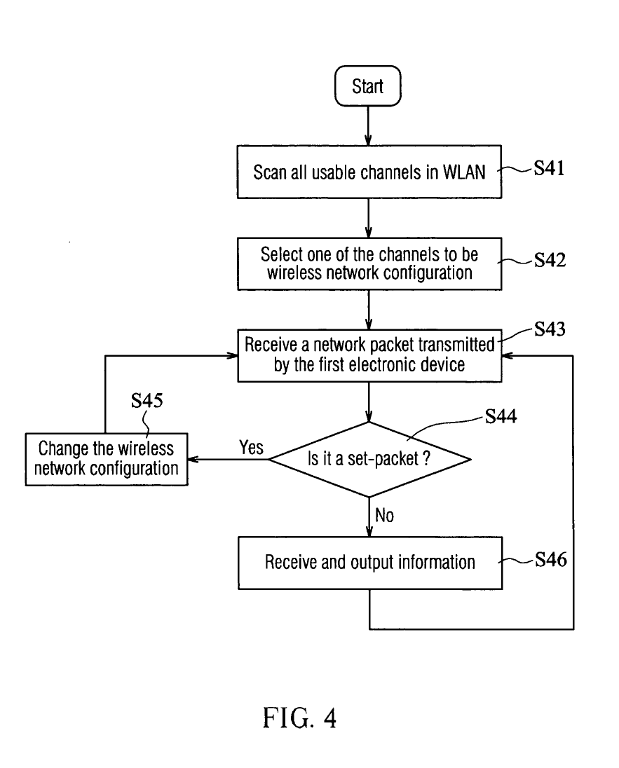

Referring to FIG. 4, it illustrates the operating process of the second electronic devices 22, 23. First, the second electronic devices 22, 23 scan all usable channels in the WLAN (S41) and each of the second electronic devices 22, 23 selects one of the channels to be its wireless network configuration (S42). For instance, WLAN based on the IEEE 802.11b WLAN protocol specifies at least three bands, and for North American region standard, the central frequencies of the three bands are 2412 MHz, 2437 MHz, and 2462 MHz. The second electronic devices 22, 23 scan the aforementioned bands. Each of the second electronic devices 22, 23 randomly generates a set of SSID and sets its wireless network configuration to an unused channel (a clean channel) or a channel with less interference to be the communication channel of its wireless network configuration.

Next, each of the second electronic devices 22, 23 receives a network packet transmitted by the first electronic device 21 (S43). The second electronic devices 22, 23 make a judgment after receiving the network packet (S44). For example, the second electronic device 22 has been designated to be the primary receiving end and therefore does not need to change its wireless network configuration in order to receive information transmitted by the first electronic device 21. The remaining electronic device 23 would first receive a set-packet, and then change its wireless network configuration according to the wireless network configuration information in the set-packet (S45). Last, the second electronic devices 22, 23 receive information transmitted by the first electronic device 21 and output the same (S46). In the process of S46, the second electronic device 22 communicates with the first electronic device 21 on a one-to-one basis, receiving the information transmitted by the first electronic device 21 and outputting the same, whereas the second electronic 23 uses the transmission characteristics of WLAN to intercept and receive the information transmitted by the first electronic device 21 and output the same.

It is to be noted that the second electronic devices 22, 23 can be connected to a third electronic device via signals, wherein the second electronic devices 22, 23 output the received information to the third electronic device for playing or displaying. The second electronic devices 22, 23 can be integrated with the third electronic device, for example, each of the second electronic devices 22, 23 can be a computer, a PDA, or a mobile phone. The second electronic devices 22, 23 can also be connected to the third electronic device via signals by way of wired or wireless means, for example, each of the second electronic devices 22, 23 can be a wireless projector adapter, a wireless setup box, a wireless DMA, a wireless optical disc player, a wireless DVD player, a wireless video recorder, a wireless game console, or a wireless portable media player. The third electronic device can be a video device, an audio device, or a combination thereof; for example, it can be a computer, a PDA, a mobile phone, a projector, a screen, a television, a sound system, a speaker, or a music player.

A system of transmitting information from one to many terminals via WLAN according to a preferred embodiment of the invention includes a first electronic device 21 and a plurality of second electronic devices 22, 23, which are in communication with one another via WLAN. In the system, the first electronic device 21 searches for the plurality of second electronic devices 22, 23 that have set their wireless network configurations, and designates one of the plurality of second electronic devices to be a primary receiving end, for example, designating the second electronic device 22 to be the primary receiving end. The first electronic device 21 also requests the rest of the plurality of the second electronic devices 23 to change the channel of their wireless network configurations to be the same as the channel of wireless network configuration of the second electronic device 22. The first electronic device 21 then transmits information to the primary receiving end, and the second electronic devices 23 intercept and receive the information transmitted by the first electronic device 21.

The system of transmitting information from one to many terminals via WLAN according to a preferred embodiment of the invention further includes a third electronic device, which is connected to the second electronic devices 22, 23 via signals, for playing or displaying the information received by the second electronic devices 22, 23. The other technical characteristics of the system according to the preferred embodiment of the invention are as aforementioned and therefore will not be further described herein.

The preferred embodiment of the invention is implemented in ad-hoc mode WLAN, but is not limited to it; it can also be implemented in infrastructure mode WLAN. For example, when implementing the method or system of the invention, the transmitting end and receiving ends switch to ad-hoc mode for transmitting information, and switch back to infrastructure mode thereafter.

According to the method and system of transmitting information from one to many terminals via WLAN of the invention, since the first electronic device 21 communicates on a one-to-one basis with the second electronic device 22, the second electronic device 22 can check whether a network packet is lost or incorrect and in return, provides an acknowledgement (ACK) or requests for the network packet to be resent, and so problems that a broadcast packet is lost or incorrect can be avoided. Moreover, according to the method and system of transmitting information from one to many terminals via WLAN of the invention, the user at the transmitting end can set the wireless network configurations of a plurality of receiving ends at once, saving the bandwidth occupied by set-packets that are transmitted periodically.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. For example, the aforementioned embodiments are described in the context of the IEEE 802.11b WLAN protocol, but a person skilled in the art can adapt it to the IEEE 802.11 series of WLAN protocols. Also, the first electronic device can directly take the second electronic devices that it has searched to be receiving ends, omitting the step that the user selects the second electronic devices that are to receive information. Moreover, although the invention can free up the bandwidth occupied by the periodically transmitted set-packets, if the system requires special design, the transmitting end can still periodically transmit set-packets for subsequent receiving ends to join the system of the invention, and the added feature does not contradict with the technical content of the invention. Therefore, the scope of the appended claims should be accorded the broadest interpretation so as to encompass all such modifications and similar arrangements.

What is claimed is:

1. A method of transmitting information from one to many terminals via wireless local area network, which is implemented in a wireless local area network comprising a first electronic device and a plurality of second electronic devices, the method comprising:
the first electronic device searching for the plurality of second electronic devices that have set their wireless network configurations;
designating one of the plurality of second electronic devices to be a primary receiving end;
the first electronic device requesting the rest of the plurality of second electronic devices to change the channel of their wireless network configurations to be the same as that of the primary receiving end; and
the first electronic device transmitting information to the primary receiving end, and the rest of the plurality of second electronic devices intercepting the information and outputting the information.

2. The method of transmitting information from one to many terminals via wireless local area network as described in claim 1, further comprising:
each of the plurality of second electronic devices scanning all usable channels in the wireless local area network and selecting a clean channel or a channel with less interference to be its wireless network configuration.

3. The method of transmitting information from one to many terminals via wireless local area network as described in claim 1, further comprising:
the first electronic device displaying a list of the plurality of second electronic devices for a user to select which of the plurality of second electronic devices are to receive the information, and the first electronic device designating one of the selected second electronic devices to be the primary receiving end.

4. The method of transmitting information from one to many terminals via wireless local area network as described in claim 1, further comprising:
the first electronic device periodically transmitting a set-packet to the primary receiving end, and the second electronic device changing its wireless network configuration according to the wireless network configuration information in the set-packet.

5. The method of transmitting information from one to many terminals via wireless local area network as described in claim 1, further comprising:
a third electronic device signal-connected to the second electronic device for receiving the information and outputting the information.

6. The method of transmitting information from one to many terminals via wireless local area network as described in claim 5, wherein the third electronic device is integrated with the second electronic device as a whole, or is signal-connected to the second electronic device by way of wireless or wired means.

7. The method of transmitting information from one to many terminals via wireless local area network as described in claim 6, wherein the second electronic device is a computer, a personal digital assistant, a mobile phone, a wireless projector adapter, a wireless setup box, a wireless digital media adapter, a wireless optical disc player, a wireless DVD player, a wireless video recorder, a wireless game console, or a wireless portable media player.

8. The method of transmitting information from one to many terminals via wireless local area network as described in claim 5, wherein the third electronic device is a video device, an audio device, or a combination thereof.

9. The method of transmitting information from one to many terminals via wireless local area network as described in claim 8, wherein the third electronic device is a computer, a personal digital assistant, a mobile phone, a projector, a screen, a television, a sound system, a speaker, or a music player.

10. The method of transmitting information from one to many terminals via wireless local area network as described in claim 1, wherein the first electronic device is a computer, a personal digital assistant, a mobile phone, a wireless projector adapter, a wireless setup box, a wireless digital media adapter, a wireless optical disc player, a wireless DVD player, a wireless video recorder, a wireless game console, or a wireless portable media player.

11. The method of transmitting information from one to many terminals via wireless local area network as described in claim 1, wherein the information is in a form of video, audio, image, graphics, text, presentation, or any combination thereof.

12. The method of transmitting information from one to many terminals via wireless local area network as described in claim 1, wherein the wireless local area network is in compliance with the IEEE 802.11 series of wireless local area network protocols.

13. A system of transmitting information from one to many terminals via wireless local area network, comprising:
a first electronic device for transmitting information; and
a plurality of second electronic devices for receiving the information and outputting the same, the plurality of second electronic devices being signal-connected to the first electronic device via a wireless local area network;
wherein the first electronic device searches for the plurality of second electronic devices that have set their wireless network configurations and designates one of the plurality of second electronic devices to be a primary receiving end; the first electronic device requests the rest of the plurality of second electronic devices to change the channel of their wireless network configurations to be the same as that of the primary receiving end; and the first electronic device transmits information to the primary receiving end and the rest of the second electronic devices intercepts the information.

14. The system of transmitting information from one to many terminals via wireless local area network as described in claim 13, wherein each of the plurality of second electronic devices scans all usable channels in the wireless local area network and selects a clean channel or a channel with less interference to be its wireless network configuration.

15. The system of transmitting information from one to many terminals via wireless local area network as described in claim 13, wherein the first electronic device displays a list of the plurality of second electronic devices for a user to select which of the plurality of second electronic devices are to receive the information, and the first electronic device designates one of the selected second electronic devices to be the primary receiving end.

16. The system of transmitting information from one to many terminals via wireless local area network as described in claim 13, wherein the first electronic device periodically transmits a set-packet to the primary receiving end and the second electronic device changes its wireless network configuration according to the wireless network configuration information in the set-packet.

17. The system of transmitting information from one to many terminals via wireless local area network as described in claim 13, further comprising:
a third electronic device signal-connected to the second electronic device for receiving the information and outputting the information.

18. The system of transmitting information from one to many terminals via wireless local area network as described in claim 17, wherein the third electronic device is integrated with the second electronic device as a whole, or is signal-connected to the second electronic device by way of wireless or wired means.

19. The system of transmitting information from one to many terminals via wireless local area network as described in claim 18, wherein the second electronic device is a computer, a personal digital assistant, a mobile phone, a wireless projector adapter, a wireless setup box, a wireless digital media adapter, a wireless optical disc player, a wireless DVD player, a wireless video recorder, a wireless game console, or a wireless portable media player.

20. The system of transmitting information from one to many terminals via wireless local area network as described in claim 17, wherein the third electronic device is a video device, an audio device, or a combination thereof.

21. The system of transmitting information from one to many terminals via wireless local area network as described in claim 20, wherein the third electronic device is a computer, a personal digital assistant, a mobile phone, a projector, a screen, a television, a sound system, a speaker, or a music player.

22. The system of transmitting information from one to many terminals via wireless local area network as described in claim 13, wherein the first electronic device is a computer, a personal digital assistant, a mobile phone, a wireless projector adapter, a wireless setup box, a wireless digital media adapter, a wireless optical disc player, a wireless DVD player, a wireless video recorder, a wireless game console, or a wireless portable media player.

23. The system of transmitting information from one to many terminals via wireless local area network as described in claim 13, wherein the information is in a form of video, audio, image, graphics, text, presentation, or any combination thereof.

24. The system of transmitting information from one to many terminals via wireless local area network as described in claim 13, wherein the wireless local area network is in compliance with the IEEE 802.11 series of wireless local area network protocols.
